(19) United States
(12) Patent Application Publication
(10) Pub. No.: US 2018/0045545 A1
(43) Pub. Date: Feb. 15, 2018

(54) MAGNETO-INDUCTIVE FLOW MEASURING DEVICE WITH REDUCED ELECTRICAL CURRENT DRAW

(71) Applicant: Endress + Hauser Flowtec AG, Reinach (CH)

(72) Inventors: Nikolai Fink, Aesch (CH); Frank Schmalzried, Munchen (DE); Wolfgang Drahm, Erding (DE)

(21) Appl. No.: 15/556,058

(22) PCT Filed: Feb. 15, 2016
(86) PCT No.: PCT/EP2016/053094

§ 371 Date: Sep. 6, 2017

(30) Foreign Application Priority Data
Mar. 11, 2015 (DE) 10 2015 103 580.4

(51) Int. Cl. G01F 1/58

(52) U.S. Cl. CPC G01F 1/586

(57) ABSTRACT

A magneto-inductive flow measuring device for measuring the flow of a flowable medium is described. The flow measuring device includes a measuring tube, a pair of coils, which are arranged opposite one another on the measuring tube and which are designed to produce an alternating magnetic field, which can be turned on and off, and which extends essentially transversely to the longitudinal axis of the measuring tube, as well as a pair of permanent magnets, which are arranged opposite one another on the measuring tube and which are designed to produce a permanent magnetic field, which extends essentially transversely to the longitudinal axis of the measuring tube. Moreover, the flow measuring device includes one or more pairs of measuring electrodes arranged opposite one another on the measuring tube, of which one pair of measuring electrodes is designed, in the case of turned off alternating magnetic field, to tap a measurement voltage induced by the permanent magnetic field, and an evaluation unit, which is designed, in the case of turned off alternating magnetic field, to monitor the measurement voltage induced by the permanent magnetic field, at least in the case of a predefined change of the measurement voltage, to turn on the alternating magnetic field and, by means of the alternating magnetic field, to determine a measured value for the flow.

The invention relates to a magneto-inductive flow measuring device for measuring the flow of a flowable medium as well as to a method for determining flow in a measuring tube.

In process automation technology, field devices are often applied, which serve for registering and/or influencing process variables. Examples of such field devices are fill level measuring devices, mass flow measuring devices, pressure- and temperature measuring devices, etc., which, as sensors, register the corresponding process variables, fill level, flow, pressure, and temperature, respectively.

A large number of such field devices are manufactured and sold by the firm, Endress+Hauser.

Especially for measuring flow through a measuring tube, a large number of different measuring principles are applied. An important measuring principle is magneto-inductive flow measurement. Magneto-inductive flow measuring devices utilize the principle of electrodynamic induction for volumetric flow measurement. Charge carriers of the medium moved perpendicularly to a magnetic field induce a measurement voltage in measuring electrodes arranged essentially perpendicularly to the flow direction of the medium and perpendicularly to the direction of the magnetic field. The measurement voltage induced in the measuring electrodes is proportional to the flow velocity of the medium averaged over the cross section of the measuring tube, thus proportional to the volume flow.

For the performing the measuring, as a rule, an alternating magnetic field is applied, which is produced by means of a coil system. The electrical current consumption of the magneto-inductive flow measuring device, is, in such case, principally caused by the electrical current draw of the coils for producing the alternating magnetic field.

It is an object of the invention to provide a magneto-inductive flow measuring device, which has a lessened electrical current consumption.

This object is achieved by the features set forth in claims 1 and 17.

Advantageous further developments of the invention are given in the dependent claims.

A magneto-inductive flow measuring device corresponding to forms of embodiment of the invention serves for measuring flow of a flowable medium.

The flow measuring device includes a measuring tube, a pair of coils, which are arranged opposite one another on the measuring tube and which are designed to produce an alternating magnetic field, which can be turned on and off, and which extends essentially transversely to the longitudinal axis of the measuring tube, as well as a pair of permanent magnets, which are arranged opposite one another on the measuring tube and which are designed to produce a permanent magnetic field, which extends essentially transversely to the longitudinal axis of the measuring tube. Moreover, the flow measuring device includes one or more pairs of measuring electrodes arranged opposite one another on the measuring tube, of which one pair of measuring electrodes is designed, in the case of turned off alternating magnetic field, to tap a measurement voltage induced by the permanent magnetic field, and an evaluation unit, which is designed, in the case of turned off alternating magnetic field, to monitor the measurement voltage induced by the permanent magnetic field, at least in the case of a predefined change of the measurement voltage, to turn the alternating magnetic field on and, by means of the alternating magnetic field, to determine a measured value for the flow.

The flow measuring device corresponding to forms of embodiment of the present invention includes a pair of permanent magnets, which are arranged opposite one another on the measuring tube. These permanent magnets are designed to produce a permanent magnetic field throughout the cross section of the measuring tube. When the medium flows with a certain flow velocity through the measuring tube, also in the case of turned off alternating magnetic field, this permanent magnetic field induces a measurement voltage in the direction perpendicular to the magnetic field. This induced measurement voltage depends on the flow velocity of the medium, so that, based on the measurement voltage induced by the permanent magnet field, flow as a function of time can be followed. Thus, even in the case of turned off alternating magnetic field, it is possible to detect changes in the flow.

When, in this way, a change in the flow is detected, the alternating magnetic field can be turned on for a certain time span for performing an exact flow measurement. With the help of the alternating magnetic field, then an exact flow measurement is performed. The alternating magnetic field is only turned on, when, as a result of a change in the flow, a new measured value for the flow is required. Otherwise, the alternating magnetic field remains turned off.

The alternating magnetic field is thus not continually turned on, but, instead, only from time to time. So long as the alternating magnetic field is turned off, only very little electrical current is consumed. Averaged over time, this significantly lessens the electrical current draw of the flow measuring device, and, averaged over time, the flow measuring device consumes significantly less power. Nevertheless, a sufficiently exact monitoring of the flow can be assured.

The invention will now be explained in greater detail based on examples of embodiments illustrated in the drawing, the figures of which show as follows:

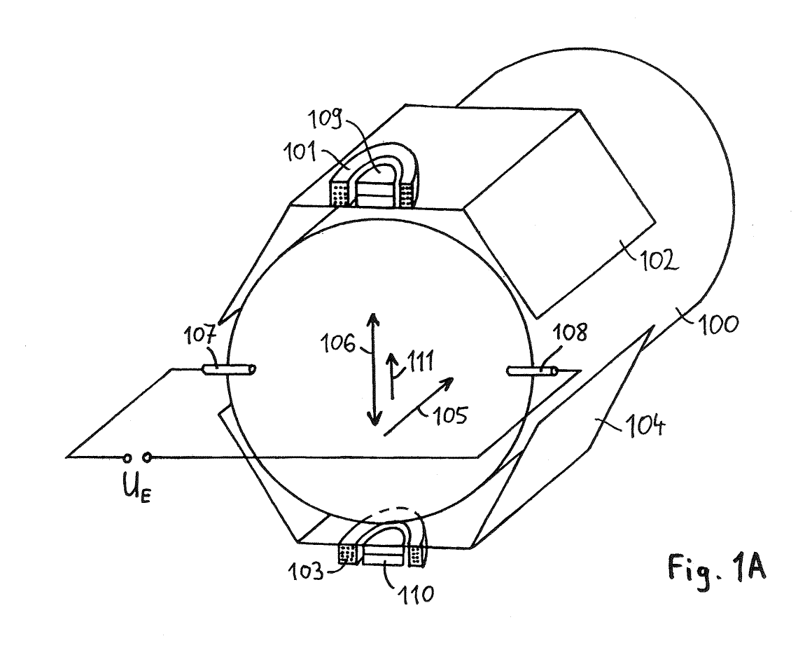

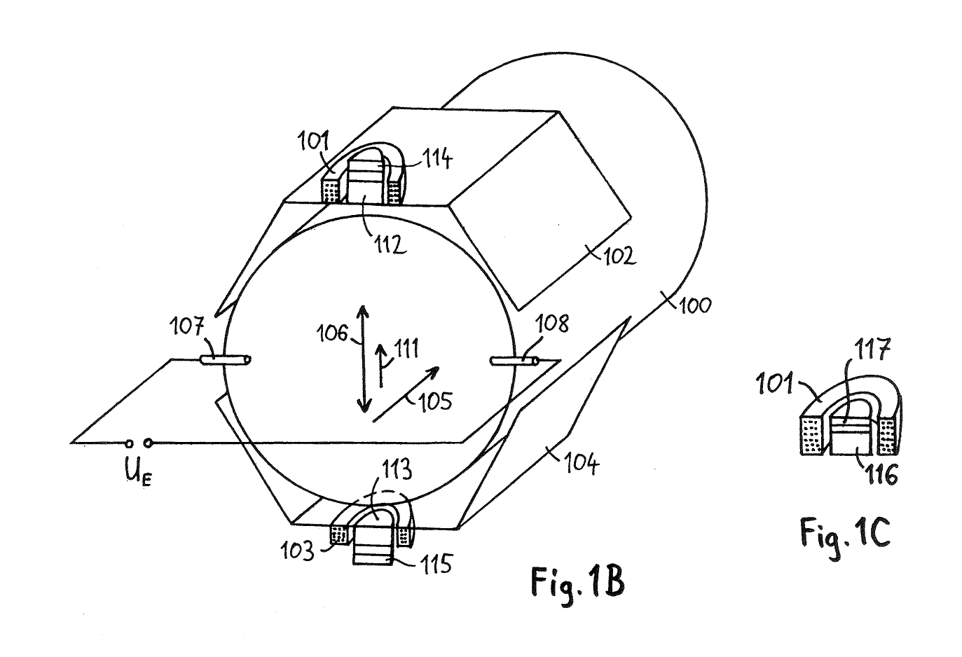

FIG. 1A a magneto-inductive flow measuring device, in the case of which permanent magnets are arranged within the coils;

FIG. 1B a magneto-inductive flow measuring device, in the case of which the permanent magnets are placed above or below the coil cores;

FIG. 1C another option for implementing the coil system of a magneto-inductive flow measuring device;

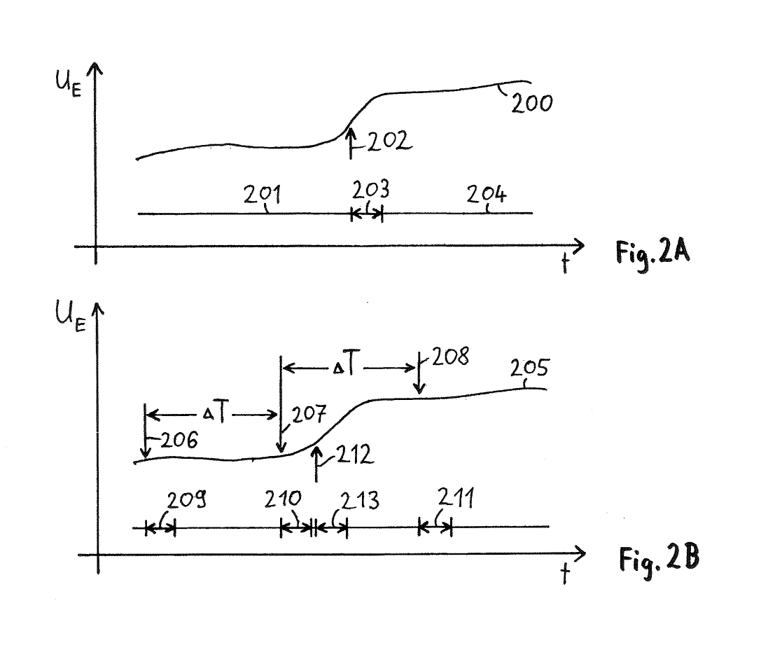

FIG. 2A a first measurement setup for determining flow in the measuring tube;

FIG. 2B a second measurement setup for determining flow in the measuring tube;

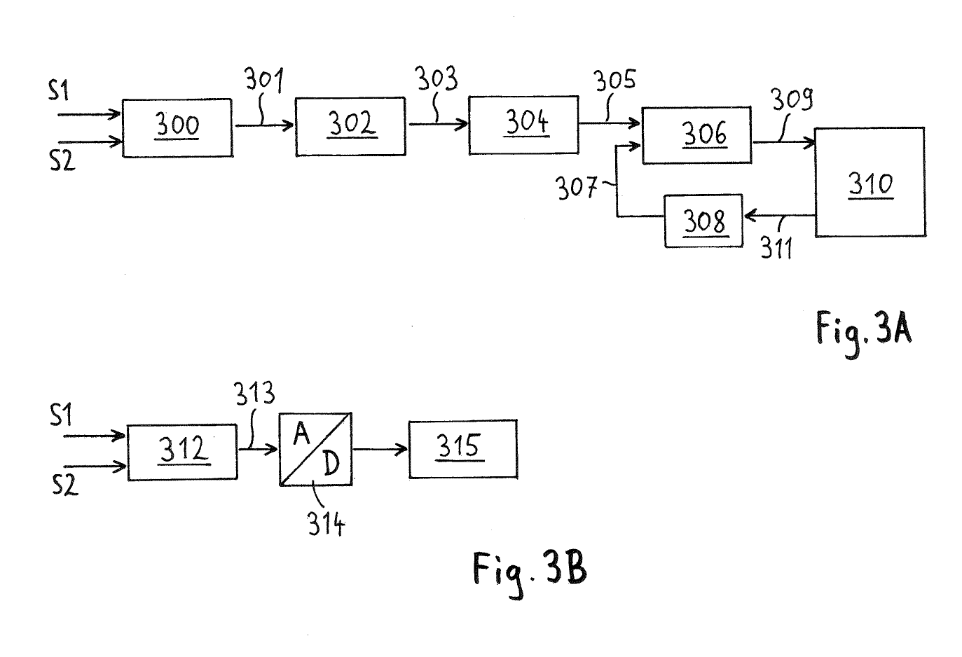

FIG. 3A an analog evaluation unit for evaluating the measurement voltage;

FIG. 3B an evaluation unit with digital signal processing for evaluating the measurement voltage;

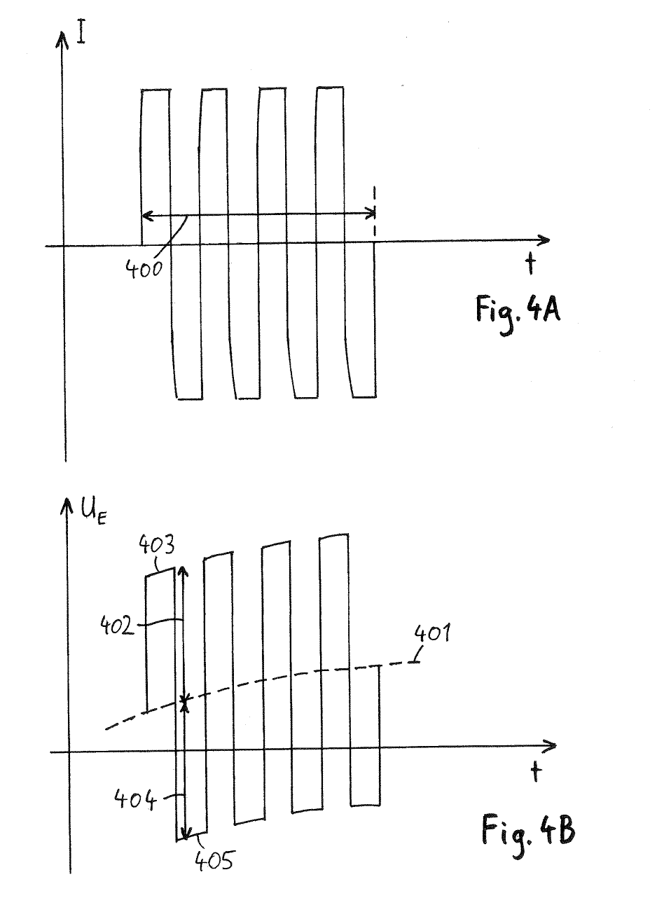

FIG. 4A electrical current through the coils as a function of time;

FIG. 4B measurement voltage U_{E} induced by the alternating magnetic field as a function of time;

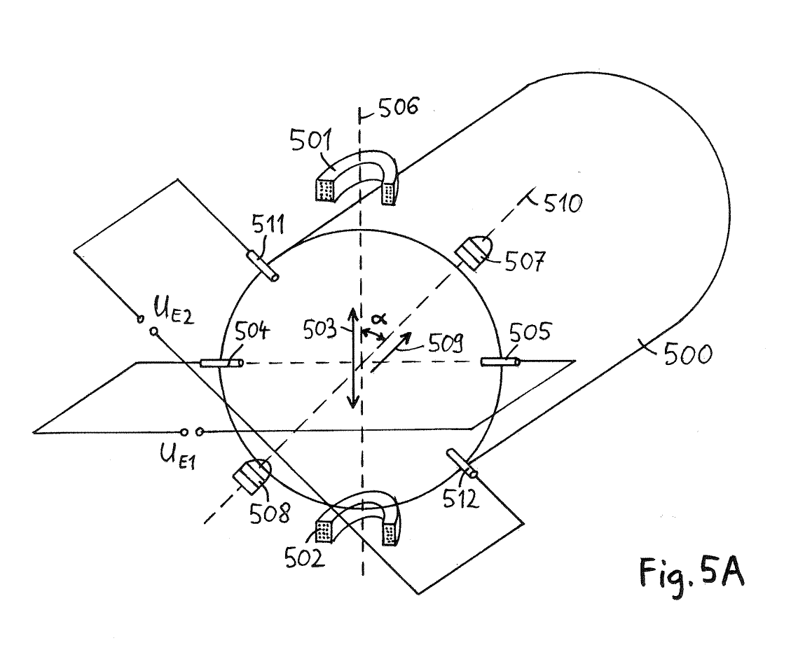

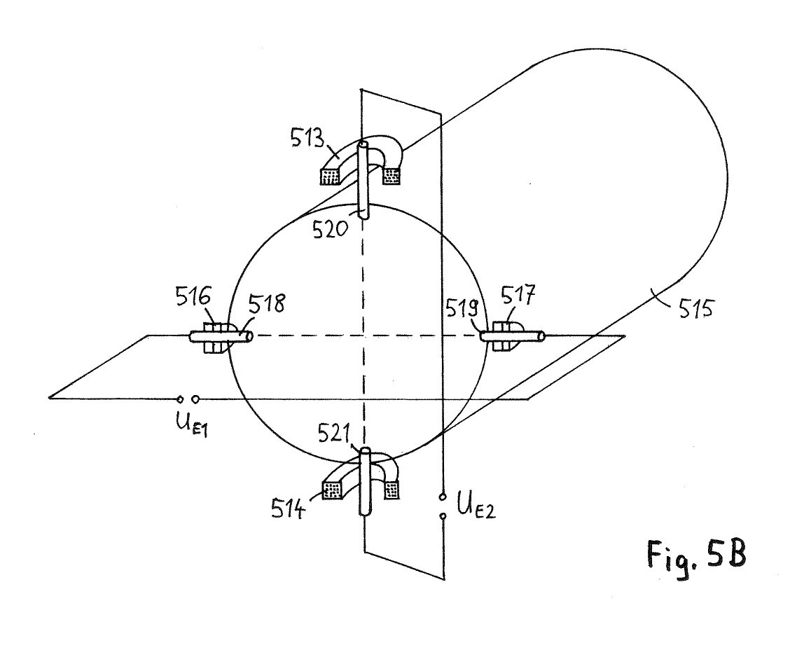

FIG. 5A another geometric arrangement of the coils and permanent magnets of the magneto-inductive flow measuring device;

FIG. 5B a particular geometric arrangement, in the case of which the permanent magnets are oriented perpendicularly to the coils; and

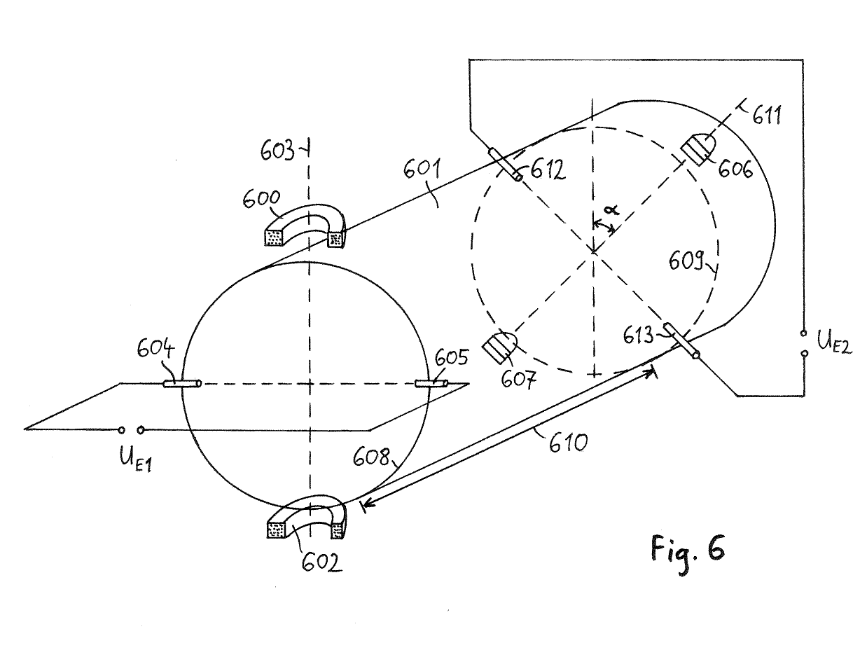

FIG. 6 another geometric arrangement, in the case of which the coils and the permanent magnets are arranged in cross-sectional planes of the measuring tube spaced from one another.

Magneto-inductive flow measuring devices utilize the principle of electrodynamic induction for volumetric flow measurement and are known from a large number of publications. Charge carriers of the medium moved perpendicularly to a magnetic field induce a measurement voltage in measuring electrodes arranged essentially perpendicularly to the flow direction of the medium and perpendicularly to the direction of the magnetic field. The measurement voltage induced in the measuring electrodes is proportional to the flow velocity of the medium averaged over the cross section of the measuring tube, and is thus proportional to the volume flow. If the density of the medium is known, the mass flow in the pipeline, or in the measuring tube, as the case may be, can be determined. The measurement voltage is usually tapped via a measuring electrode pair, which is arranged relative to the coordinate along the measuring tube axis in the region of maximum magnetic field strength and where, thus, the maximum measurement voltage is to be expected. The electrodes are usually galvanically coupled with the medium; however, also magneto-inductive flow measuring devices with contactless, capacitively coupling electrodes are known.

The measuring tube can be manufactured, in such case, either from an electrically conductive, non-magnetic material, e.g. stainless steel, or from an electrically insulating material. If the measuring tube is manufactured from an electrically conductive material, then it must be lined with a liner of an electrically insulating material in the region coming in contact with the medium. The liner is composed, depending on temperature and medium, for example, of a thermoplastic, a thermosetting or an elastomeric, synthetic material. Known, however, are also magneto-inductive flow measuring devices with a ceramic lining.

An electrode can be subdivided essentially into an electrode head, which comes at least partially in contact with a medium, which flows through the measuring tube, and an electrode shaft, which is contained almost completely in the wall of the measuring tube.

The electrodes are, besides the magnet system, central components of a magneto-inductive flow measuring device. In the case of the embodiment and arrangement of the electrodes, it is desirable that they can be assembled as simply as possible into the measuring tube and that subsequently in measurement operation no sealing problems occur; moreover, the electrodes should be distinguished by a sensitive and simultaneously low-disturbance measurement signal registration.

Besides the measuring electrodes, which serve for tapping a measurement signal, often additional electrodes are installed in the measuring tube in the form of reference- or grounding electrodes, which serve to measure an electrical reference potential or to detect a partially filled measuring tube or to register the temperature of the medium by means of an installed temperature detector.

As a rule, the magnet system of a magneto-inductive flow measuring device includes a coil pair, which is designed to produce an alternating magnetic field, which extends through the total cross section of the measuring tube. For producing the alternating magnetic field, the coils are fed by a clocked, direct current, which changes direction, for example, with a frequency of 8 Hz, or 16 Hz.

The continuous electrical current flow through the coil pair of the magnet system leads to an accordingly high power consumption in the case of magneto-inductive flow measuring devices. In such case, the power consumption depends especially on the tube cross section, wherein, in the case of greater tube cross sections, a higher power is required for producing the alternating magnetic field than in the case of lesser tube cross sections. In general, there is in the case of magneto-inductive flow measuring devices a need to lessen the electrical current draw. Especially in the case of two-conductor-field devices and in the case of battery operated field devices, a lessening of the electrical current draw would be of interest.

In the case of two-conductor field devices, both the power supply as well as also the measured value transmission occur via one pair of connection lines. Since in the case of many two-conductor field devices the measured values are transmitted in the form electrical current values, the field device must frequently operate for longer time periods with a comparatively low electrical current.

In the case of battery operated field devices, the supply of the field device occurs via an internal battery. Battery operated field devices are frequently used in poorly accessible locations and are, as a rule, not connected to a fieldbus. In order to enable a longer battery service life, also in this case a lessening of the power consumption of the flow measuring device would be desirable.

For lessening the electrical current draw of magneto-inductive flow measuring devices, it is proposed to utilize for monitoring the flow a permanent magnetic field produced by permanent magnet, in which case no electrical current is consumed for producing the field, and to turn the coil system of the flow measuring device responsible for the actual electrical current draw on only from time to time.

FIG. 1A shows a magneto-inductive flow measuring device, which works according to this principle. For producing the alternating magnetic field required for the flow measurement, a coil system is provided. The coil system includes a first coil 101 and a first pole shoe 102 arranged above the measuring tube 100 as well as a second coil 103 and a second pole shoe 104 arranged below the measuring tube 100. The two coils 101, 103 are designed to produce an alternating magnetic field oriented perpendicularly to the flow direction 105 of the medium. The pole shoes 102, 104 are so embodied that the magnetic field produced by the coils 101, 103 obeys a desired mathematical function, which assures an as linear as possible measurement behavior in the case of different flow profiles.

The direction of the alternating magnetic field produced by the coils 101, 103 is shown in FIG. 1A by the double arrow 106. Movement of charge carriers of the medium perpendicularly to the magnetic field induces a measurement voltage U_{E}, which can be tapped via the two measuring electrodes 107, 108. In this regard, the two measuring electrodes 107, 108 are arranged essentially perpendicularly to the flow direction 105 of the medium and perpendicularly to the direction of the alternating magnetic field. The measurement voltage U_{E} tapped on the measuring electrodes 107, 108 is directly proportional to the flow velocity v of the medium. The faster the medium in the measuring tube 100 flows, the higher is the voltage U_{E} tappable on the measuring electrodes 107, 108.

In the case of the flow measuring device shown in FIG. 1A, supplementally to the coils 101, 103, two permanent magnets 109, 110 are arranged above and below the measuring tube 100. The first permanent magnet 109 is arranged in the interior of the coil 101 above the measuring tube 100, and the second permanent magnet 110 is arranged in the interior of the coil 103 below the measuring tube 100. The two permanent magnets 109, 110 produce throughout the cross section of the measuring tube 100 a permanent magnetic field, which extends in the direction of the arrow 111. When the two coils 101, 103 are turned off and no alternating magnetic field is being produced, the two permanent magnets 109, 110 are nevertheless producing a permanent magnetic field. This permanent magnetic field also induces in the flowing medium in the case of turned off alternating magnetic field a measurement voltage U_{E}, which can be tapped on the measuring electrodes 107, 108. The measurement voltage U_{E} depends, in such case, on the flow velocity of the medium.

The measurement voltage induced by the permanent magnetic field U_{E} is influenced by electrochemical potential influences and is, consequently, not suited for an exact determination of the absolute flow value. However, the measurement voltage U_{E} induced by the two permanent magnet 109, 110 is quite well suited for monitoring flow is a function of time and for detecting significant changes of the flow. When such a significant change of the flow is detected, the alternating magnetic field produced by the coils 101 and 103 is turned on for a certain time span, in order to perform an exact measuring of the changed flow.

In contrast with solutions of the state of the art, the coils 101, 103 are thus not continually turned on, but, instead, are only activated from time to time, for example, when, as a result of a flow change, a new determination of the flow is required. The coils 101, 103 are thus only turned on during certain time spans. In this way, the average power consumption of the magneto-inductive flow measuring device can be significantly decreased. In this way, magneto-inductive flow measuring devices can be built, which have a significantly lessened electrical current requirement.

FIG. 1B shows a further magneto-inductive flow measuring device, wherein the coil system of the flow measuring device shown in FIG. 1B differs from the coil system shown in FIG. 1A. In FIG. 1B, features, which are equal or similar to the features already shown in FIG. 1A, are provided with the same reference characters as in FIG. 1A, so that subsequently only differences will be explored and reference is otherwise taken to the description of FIG. 1A.

In contrast to FIG. 1A, coil cores 112, 113 are arranged within the coils 101, 103. The presence of these coil cores 112, 113 in the interior of the coils 101, 103 causes the alternating magnetic field to be strengthened and led to the pole shoes 102, 104. The first permanent magnet 114 is arranged above the coil core 112 and adjoins the coil core 112. The second permanent magnet 115 is arranged below the coil core 113 and adjoins the coil core 113. Although the permanent magnets 114, 115 are arranged, in each case, on the ends of the coil cores 112, 113 facing away from the measuring tube 100, the permanent magnetic field produced by them is strong enough to pass through the interior of the measuring tube 100 with a uniform permanent magnetic field.

FIG. 1C shows another option for embodiment of the coil system, wherein here only the first coil 101 is shown. Arranged in the interior of the first coil 101 is a coil core 116, which, however, only partially fills the interior of the coil. The rest of the coil interior is filled by a permanent magnet 117, which adjoins the coil core 116 and partially replaces the coil core 116. In the case of the solution shown in FIG. 1C, the permanent magnet 117 ends flush with the first coil 101. Alternatively thereto the permanent magnet 117 also could extend out above the first coil 101.

FIG. 2A illustrates the measuring principle. Plotted along the vertical axis is the measurement voltage U_{E}, which is caused by the permanent magnetic field and which can be tapped on the measuring electrodes 105, 106 in the case of turned off alternating magnetic field. Plotted along the horizontal axis is the time t. The curve 200 shows the measurement voltage U_{E} tappable on the measuring electrodes 105, 106 as a function of time. During the time interval 201, the measurement voltage U_{E} changes only slightly, so that no exact measuring is initiated. Only at the point in time 202 is a significant rise of the measurement voltage U_{E} detected. Accordingly, during the thereon following time span 203, the alternating magnetic field is turned on, and a more exactly measured value determined for the flow. During the following time interval 204, the changes of the tapped measurement voltage U_{E} are again relatively small. Therefore, during the time interval 204, no exact measuring of the flow value is initiated.

In the case of the measuring illustrated in FIG. 2A, an exact measuring of the flow is initiated only when a significant change of the tapped measurement voltage U_{E} is detected, thus, for example, at the point in time 202. In addition to these measurements, which are initiated in the case of significant changes of the flow, exact measurements of the flow can also be performed in regular time intervals ΔT.

Such a measurement procedure is shown in FIG. 2B. The curve 205 shows measurement voltage U_{E} as a function of time. In regular time intervals ΔT, an exact determining of flow is performed, thus at the points in time 206, 207, 208. For performing the exact measurements, the alternating magnetic field is turned on during the time intervals 209, 210, 211. Moreover, at the point in time 212, a significant rise of the measurement voltage U_{E} is detected, and, consequently, during the thereon following time interval 213, the alternating magnetic field is likewise turned on. On the whole, the alternating magnetic field is thus only turned on during the time intervals 209, 210, 211, 213. For the rest of the time, the alternating magnetic field remains turned off, which leads to a considerable sinking of the average electrical current consumption. In this way, magneto-inductive flow measuring devices can be built, which have a clearly lessened electrical current requirement. This is especially advantageous for two-conductor field devices and battery driven field devices.

FIG. 3A shows an evaluating circuit for monitoring the measurement voltage induced by the permanent magnetic field. The signal voltages S1 and S2 tappable on the two measuring electrodes 107, 108 are fed to a difference amplifier 300, which subtracts the two signal voltages S1 and S2 from one another. The so obtained difference signal 301 is sent through a filter 302.

The filter 302 serves mainly for filtering out disturbance signals. The filtered signal 303 is fed to a differentiator 304, which forms the derivative of the filtered signal 303. Based on the derivative, it can be detected how strongly the filtered signal 303 changes per unit time. The derivative signal 305 is fed to a comparator 30, where it is compared with a limit value 307, which is provided by a reference value unit 308. So long as the derivative signal 305 lies below the limit value 307, no new flow measurement is initiated, and the magneto-inductive measuring system 310 remains turned off. As soon, however, as the derivative signal 305 exceeds the limit value 307, the comparator 306 produces a switch-on signal 309 (a so-called “wake-up signal”), which turns the magneto-inductive measuring system 310 on for producing the alternating magnetic field and a new flow measurement is initiated using the alternating magnetic field.

The limit value 307 is provided by the reference value unit 308. In such case, it is advantageous that the limit value 307 produced by the reference value unit 308 be adapted dynamically as a function of the required accuracy of the flow measurement. Conforming the limit value establishes how frequently a new determination of the flow value is performed. When a comparatively high limit value is set, an exact measuring the flow is initiated only in the case of relatively strong changes of the flow, and the measurements then occur relatively infrequently. When the limit value is, in contrast, selected relatively low, then the limit value is frequently exceeded, and, accordingly, an exact measuring of the flow value is initiated frequently. By adjusting the limit value, the accuracy, with which the flow is tracked, can be established dynamically.

In such case, it can be provided that the limit value 307 of the reference value unit 308 is set from the magneto-inductive measuring system 310 with the assistance of a control signal 311. When the flow measurements occur too frequently, the limit value 307 is increased by the magneto-inductive measuring system 310. When the flow measurements occur too infrequently, the limit value 307 is reduced.

FIG. 3B shows another evaluation unit, in the case of which the measurement voltage induced by the permanent magnetic field is evaluated by means of digital signal processing. The signal voltages S1 and S2 tappable on the two measuring electrodes 107, 108 are fed to a difference amplifier 312, which subtracts the two signal voltages S1 and S2 from one another. The so obtained difference signal 313 is then fed to an analog/digital converter 314, which converts the analog signal into a sequence of digital, sampled values. These digital, sample values are then fed to a microprocessor 315 (or to a digital signal processor), which ascertains how strongly the measurement voltage U_{E} changes per unit time. When the voltage change ΔU_{E} per unit time Δt exceeds, for example, a predetermined limit value, an exact measuring of the flow is initiated.

FIGS. 4A and 4B show how an exact measurement of the flow is performed with the assistance of the alternating magnetic field produced by the coils 101, 103. Such flow measurements are performed during the time interval 203 in FIG. 2A and during the time intervals 209, 210, 211, 213 in FIG. 2B. For producing the alternating magnetic field, the two coils 101, 103 are fed with a clocked, direct current, which is plotted in FIG. 4A as a function of time. Plotted along the vertical axis is the electrical current I through the two coils 101, 103, and plotted along the horizontal axis is the time t. It can be seen that the clocked, direct current changes its polarity with a predetermined frequency (for example, 8 Hz, or 16 Hz). As a result of this alternating electrical current flow through the coils 101, 103, the coils 101, 103 produce an alternating magnetic field, whose direction continually changes corresponding to the direction of the electrical current flow shown in FIG. 4A. During the measurement interval 400 shown in FIG. 4A, the magnetic field changes direction, for example, a total of eight times.

As a result of the alternating magnetic field and the movement of the charge carriers of the flowing medium, a measurement voltage U_{E} is induced in the direction transverse to the measuring tube 100 and can be tapped on the two measuring electrodes 107, 108. This measurement voltage U_{E} is plotted in FIG. 4B as a function of time. FIG. 4B shows that the measurement voltage U_{E} changes with the frequency of the alternating magnetic field. So long as the magnetic field is oriented in a first direction, thus, for example, upwardly, an induced voltage 402 of positive sign is superimposed on the dashed voltage offset 401, and one obtains a first measurement voltage value 403. As soon as the magnetic field changes direction and is oriented now in reverse direction, for example, downwardly, an induced voltage 404 of negative sign is superimposed on the voltage offset 401, and one obtains a second measurement voltage value 405. By ascertaining the difference between the first measurement voltage value 403 and the second measurement voltage value 405, one obtains a difference voltage ΔU_{E}, which is no longer dependent on the voltage offset 401. This difference voltage ΔU_{E} depends only on the magnitude B of the alternating magnetic field:

ΔU_{E}=k·B·D·v,

wherein k is a proportionality constant, D his the diameter of the measuring tube, v is the flow velocity of the medium and B the magnitude of the alternating magnetic field.

Through use of the alternating magnetic field, thus, the influence of the voltage offset 401 can be eliminated. The voltage offset 401 depends decisively on the electrochemical potential of the two measuring electrodes 107, 108, which can change in the course of time and is subject to a permanent drift. Moreover, the voltage offset 401 is also a result of the induced voltage contribution brought about by the permanent magnetic field produced by the two permanent magnets 109, 110. The magnetic field component produced by the two permanent magnets 109, 110 does not disturb the exact determining of flow velocity v and of the flow, because this permanent magnetic field contributes only to the voltage offset 401, which is, in any event, eliminated by the difference forming. Thus, an exact determining of flow velocity v can be performed by measuring with the alternating magnetic field. In this way, the flow can be determined with high accuracy.

In the case of the flow measuring device shown in FIG. 1, the coils 101, 103 and the permanent magnets 109, 110 are oriented along the same axis. However, other geometric arrangements are possible. FIGS. 5A, 5B and 6 show possible alternative arrangements for the coils and the permanent magnets.

FIG. 5A shows a first coil 501 arranged above the measuring tube 500, and a second coil 502 arranged below the measuring tube 500. The alternating magnetic field produced by the two coils 501, 502 is illustrated by the double arrow 503. The two measuring electrodes 504, 505 are arranged perpendicularly to the flow direction of the medium and perpendicularly to the axis 506 fixed by the coils 501, 502. With the alternating magnetic field turned on, there can be tapped on the two measuring electrodes 504, 505 a measurement voltage U_{E1}, which enables an exact determining of the current flow value.

Additionally arranged on the measuring tube 500 at mutually opposite positions are the two permanent magnets 507, 508, which produce in the cross section of the measuring tube 500 a permanent magnetic field, whose direction is illustrated by the arrow 509. The axis 510 fixed by the two permanent magnets 507, 508 is oriented offset by an angle α from the axis 506 fixed by the coils 501, 502. The angle α should not be selected too small, because the pole shoes arranged outside the coils 501, 502 take up a certain space. For example, the angle α could be selected to equal 45°.

In contrast to the solution shown in FIG. 1, in the case of which a single measuring electrode pair was sufficient, in the case of the flow measuring device shown in FIG. 5A, a second pair of measuring electrodes 511, 512 is provided, in order to be able to tap the measurement voltage U_{E2} induced by the permanent magnets 507, 508. The two measuring electrodes 511, 512 are arranged perpendicularly to the flow direction of the medium and perpendicularly to the axis 510 fixed by the two permanent magnets 507, 508. The voltage U_{E2} tappable on the two measuring electrodes 511, 512 permits a permanent monitoring of the flow. When a more exactly measured value of the flow is required, the coil system is activated for a short time, in order to produce the alternating magnetic field required for the exact flow measurement.

FIG. 5B shows a special example, in the case of which the two coils 513, 514 are arranged above and below a measuring tube 515 and in the case of which the two permanent magnets 516, 517 are arranged perpendicularly to the direction fixed by the two coils 513, 514. When the two coils 513, 514 are supplied with a clocked, direct current, they produce an alternating magnetic field. The voltage U_{E1} induced by the alternating magnetic field can be tapped on the two measuring electrodes 518, 519 arranged perpendicularly to the coils 513, 514. The two measuring electrodes 518, 519 can extend, for example, through bores in the permanent magnet 516, 517, into the interior of the measuring tube 515. The evaluation of the voltage U_{E1} induced by the alternating magnetic field measurement enables an exact determining of the current flow value.

The two permanent magnets 516, 517 are arranged in FIG. 5B perpendicularly to the two coils 513, 514 and produce throughout the cross section of the measuring tube 515 a permanent magnetic field. As a result of this permanent magnetic field, there is induced perpendicularly to the two permanent magnets 516, 517 a measurement voltage U_{E2}, which can be tapped by the two measuring electrodes 520, 521. These two measuring electrodes 520, 521 extend through the coils 513, 514 into the interior of the measuring tube 515. Based on the measurement voltage U_{E2}, the flow in the measuring tube 515 can be permanently monitored, wherein, when required, the alternating magnetic field is turned on and an exact flow measurement initiated using the alternating magnetic field.

FIG. 6 shows another geometric arrangement of coils and permanent magnets in a magneto-inductive flow measuring device. The coil system of the flow measuring device includes a first coil 600, which is arranged above the measuring tube 601, as well as a second coil 602, which is arranged below the measuring tube 601. The two coils 600, 602 are designed to produce an alternating magnetic field throughout the cross section of the measuring tube 601. Arranged perpendicularly to the axis 603 fixed by the two coils 600, 602 is a pair of measuring electrodes 604, 605, which are designed to tap the measurement voltage U_{E1} induced by the alternating magnetic field. The evaluation of this measurement voltage U_{E1} caused by the alternating magnetic field permits an exact determining of flow through the measuring tube 601.

In the case of the previously shown solutions in FIG. 1, FIG. 5A, FIG. 5B, coils and permanent magnets were, in each case, arranged in the same cross sectional plane of the measuring tube. In contrast, in FIG. 6, the coils 600, 602 and the measuring electrodes 604, 605 are arranged in a first cross sectional plane 608, while the permanent magnets 606, 607 are arranged in a second cross sectional plane 609 spaced therefrom. For tapping the voltage U_{E2} induced by the permanent magnets 606, 607, there is provided in the second cross sectional plane 609 a second pair of measuring electrodes 612, 613, which is arranged perpendicularly to the axis 611 fixed by the permanent magnets 606, 607.

The second cross sectional plane 609 is arranged a certain distance 610 from the first cross sectional plane 608. The axis 611 fixed by the two permanent magnets 606, 607 can be oriented at any angle α relative to the axis 603. The voltage U_{E2} tappable on the two measuring electrodes 612, 613 enables a continuous monitoring of the flow through the measuring tube 601. Only in the case of significant changes of the flow, or supplementally also in regular time intervals, is an exact measuring of the flow using the alternating magnetic field initiated.

1. Magneto-inductive flow measuring device for measuring flow of a flowable medium, comprising:
a measuring tube (100, 500, 515, 601),
a pair of coils (101, 103, 501, 502, 513, 514, 600, 602), which are arranged opposite one another on the measuring tube and which are designed to produce an alternating magnetic field, which can be turned on and off, and which extends essentially transversely to the longitudinal axis of the measuring tube, characterized by
a pair of permanent magnets (109, 110, 114, 115, 507, 508, 516, 517, 606, 607), which are arranged opposite one another on the measuring tube and which are designed to produce a permanent magnetic field, which extends essentially transversely to the longitudinal axis of the measuring tube,
one or more pairs of measuring electrodes arranged opposite one another on the measuring tube, of which one pair of measuring electrodes (107, 108, 511, 512, 520, 521, 612, 613) is designed, in the case of turned off alternating magnetic field, to tap a measurement voltage induced by the permanent magnetic field, and
an evaluation unit, which is designed, in the case of turned off alternating magnetic field, to monitor the measurement voltage induced by the permanent magnetic field, at least in the case of a predefined change of the measurement voltage, to turn on the alternating magnetic field, and, by means of the alternating magnetic field, to determine a measured value for the flow.

2. Flow measuring device as claimed in claim 1, characterized in that the evaluation unit is designed, at least in the case of a predefined change of the measurement voltage, to turn the alternating magnetic field on, to register a measurement voltage induced by the alternating magnetic field or by the alternating magnetic field and the permanent magnetic field, and, based on an evaluation of the measurement voltage induced by the alternating magnetic field or the alternating magnetic field and the permanent magnetic field, to determine a measured value for the flow.

3. Flow measuring device as claimed in claim 1, characterized in that the alternating magnetic field producible by the coils is oriented essentially parallel to the permanent magnetic field produced by the permanent magnets.

4. Flow measuring device as claimed in claim 3, characterized in that the flow measuring device includes a pair of measuring electrodes arranged opposite one another on the measuring tube and essentially perpendicularly to the alternating magnetic field and the permanent magnetic field, wherein the pair of measuring electrodes is designed, in the case of turned off alternating magnetic field, to tap a measurement voltage induced by the permanent magnetic field and, in the case of turned on alternating magnetic field to tap a measurement voltage induced by the alternating magnetic field or by the alternating magnetic field and the permanent magnetic field.

5. Flow measuring device as claimed in claim 3, characterized by at least one of the following:
the two permanent magnets are arranged respectively within the two coils;
the permanent magnets are arranged instead of coil cores respectively within the two coils;
the two permanent magnets are arranged coaxially centrally between the two coils;
a shared pair of pole shoes is provided for the coils and the permanent magnets;
a shared magnet system is provided for the coils and the permanent magnets, wherein the magnet system includes at least one of pole shoes, pole sheets and flux return sheets.

6. Flow measuring device as claimed in claim 3, characterized by at least one of the following:
coil cores are arranged within the two coils, and the permanent magnets are placed supplementally to the coil cores;
coil cores are arranged within the two coils, and the permanent magnets are placed supplementally to the coil cores above or below the coil cores;
coil cores are arranged within the two coils, and the permanent magnets adjoin the coil cores above or below them;
coil cores are arranged within the two coils, and the permanent magnets are placed supplementally to the coil cores and at least partially replace the coil cores;
a shared pair of pole shoes is provided for the coils and the permanent magnets;
a shared magnet system is provided for the coils and the permanent magnets, wherein the magnet system includes at least one of pole shoes, pole sheets and flux return sheets.

7. Flow measuring device as claimed in claim 1, characterized in that the alternating magnetic field producible by the coils is offset by a predetermined angle from the permanent magnetic field produced by the permanent magnets.

8. Flow measuring device as claimed in claim 7, characterized in that the flow measuring device includes a first pair of measuring electrodes arranged opposite one another on the measuring tube and arranged essentially perpendicularly to the permanent magnetic field, wherein the first pair of measuring electrodes is designed to tap a measurement voltage induced by the permanent magnetic field in the case of turned off alternating magnetic field.

9. Flow measuring device as claimed in claim 7, characterized in that the flow measuring device supplementally includes a second pair of measuring electrodes arranged opposite one another on the measuring tube and arranged essentially perpendicularly to the alternating magnetic field, wherein the second pair of measuring electrodes is designed, in the case of turned on alternating magnetic field, to tap a measurement voltage induced by the alternating magnetic field or by the alternating magnetic field and the permanent magnetic field.

10. Flow measuring device as claimed in claim 7, characterized in that the alternating magnetic field producible by the coils is essentially orthogonal to the permanent magnetic field produced by the permanent magnets.

11. Flow measuring device as claimed in claim 1, characterized in that
the pair of permanent magnets and a first pair of measuring electrodes are arranged in a first cross sectional plane of the measuring tube, wherein the first pair of measuring electrodes is arranged essentially perpendicularly to the permanent magnetic field produced by the permanent magnets, and
the pair of coils and a second pair of measuring electrodes are arranged in a second cross sectional plane of the measuring tube, which is arranged offset along the measuring tube from the first cross sectional plane, wherein the second pair of measuring electrodes is arranged essentially perpendicularly to the alternating magnetic field producible by the coils.

12. Flow measuring device as claimed in claim 1, characterized in that the evaluation unit is designed, for detection of predefined changes of the measurement voltage, to compare with a limit value changes of the measurement voltage as a function of time, and, in the case of exceeding the limit value, to turn the alternating magnetic field on and initiate a measuring of the flow using the alternating magnetic field.

13. Flow measuring device as claimed in claim 12, characterized by at least one of the following:
the limit value for the predefined change of the measurement voltage is dynamically adaptable;
the evaluation unit includes a differentiator, which is designed to form a derivative of the measurement voltage, as well as a comparator, which compares the derivative of the measurement voltage with a limit value.

14. Flow measuring device as claimed in claim 1, characterized in that the evaluation unit is designed, supplementally to the measurements of the flow value performed in the case of predefined changes of the flow, in regular time intervals to turn the alternating magnetic field on and to perform a measuring of the flow using the alternating magnetic field.

15. Flow measuring device as claimed in claim 1, characterized in that a measurement voltage offset is superimposed on the induced measurement voltage, wherein the measurement voltage offset is brought about by at least one of the following:
electrochemical effects in the liquid,
the permanent magnetic field produced by the permanent magnets.

16. Flow measuring device as claimed in claim 1, characterized in that the evaluation unit is designed, through periodic direction change of the alternating magnetic field, to eliminate a measurement voltage offset superimposed on the measurement voltage and to determine a measured value of the flow independently of the measurement voltage offset.

17. Method for determining flow in a measuring tube (100, 500, 515, 601) by means of a magneto-inductive flow measuring device, which has:
the measuring tube (100, 500, 515, 601),
a pair of coils (101, 103, 501, 502, 513, 514, 600, 602), which are arranged opposite one another on the measuring tube and which are designed to produce an alternating magnetic field, which can be turned on and off, and which extends essentially transversely to the longitudinal axis of the measuring tube,
a pair of permanent magnets (109, 110, 114, 115, 507, 508, 516, 517, 606, 607), which are arranged opposite one another on the measuring tube and which are designed to produce a permanent magnetic field, which extends essentially transversely to the longitudinal axis of the measuring tube,
one or more pairs of measuring electrodes arranged opposite one another on the measuring tube, of which one pair of measuring electrodes (107, 108, 511, 512, 520, 521, 612, 613) is designed, in the case of turned off alternating magnetic field, to tap a measurement voltage induced by the permanent magnetic field, wherein the method comprises steps as follows:
monitoring a measurement voltage induced by the permanent magnetic field in the case of turned off alternating magnetic field,
detecting a predefined change of the measurement voltage induced by the permanent magnetic field,
at least in the case of a predefined change of the measurement voltage, turning the alternating magnetic field on and performing a flow measurement by means of the alternating magnetic field.

18. Method as claimed in claim 17, characterized in that, at least when the measurement voltage exceeds a predefined change, turning the alternating magnetic field on, registering a measurement voltage induced by the alternating magnetic field or by the alternating magnetic field and the permanent magnetic field, and, based on the so registered measurement voltage, determining a measured value for the flow.
